(19) United States
(12) Patent Application Publication
(10) Pub. No.: US 2011/0204124 A1
(43) Pub. Date: Aug. 25, 2011

(54) PROCESS FOR FLUXLESS BRAZING OF ALUMINIUM AND BRAZING FILLER ALLOY FOR USE THEREIN

(75) Inventor: Adrianus Jacobus WITTEBROOD, Velserbroek (NL)

(73) Assignee: Aleris Aluminum Koblenz GmbH, Koblenz (DE)

(21) Appl. No.: 13/099,052

(22) Filed: May 2, 2011

Related U.S. Application Data
(63) Continuation-in-part of application No. 13/125,809, filed on Apr. 24, 2011.
(60) Provisional application No. 61/112,823, filed on Nov. 10, 2008.

(30) Foreign Application Priority Data
Nov. 10, 2008 (EP) EP-08168713.9

(51) Int. Cl. B23K 31/02

(52) U.S. Cl. 228/219

(57) ABSTRACT

This relates to a process for controlled atmosphere brazing including, brazing an aluminium alloy without flux in a controlled atmosphere, while using brazing sheet including an aluminium alloy core upon which on at least one side a layer of filler alloy is clad, the filler clad layer having an inner-surface and an outer-surface, the inner-surface is facing the core, and wherein the filler alloy has a composition which is Na-free, Li-free, K-free, and Ca-free, and including, in wt. %: Si 3% to 15%, Cu 0.3% to 5%, Mg 0.05% to 1%, one or more elements selected from the group of: Bi, Pb, and Sb, and the sum of these elements being 0.35% or less, Fe 0 to 0.6%, Mn 0 to 1.5%, the balance aluminium.

### CROSS-REFERENCE TO RELATED APPLICATIONS

This is a continuation-in-part of international application no. PCT/EP2009/064586, now pending as U.S. patent application Ser. No. 13/125,809, having an international filing date of Nov. 4, 2009 which claims the benefit of U.S. provisional patent application No. 61/112,823 filed on Nov. 10, 2008, now abandoned, and which claims priority under 25 USC 119 of European patent application EP-08168713.9 filed on Nov. 10, 2008, all are incorporated herein by reference in their entirety.

### FIELD OF THE INVENTION

This invention relates to a process for brazing an aluminium alloy in a controlled atmosphere without using a brazing flux material, and to the use of an aluminium-silicon filler alloy in a controlled atmosphere brazing process.

### BACKGROUND TO THE INVENTION

There are various brazing processes in use for the industrial scale manufacturing of heat exchangers.

There is vacuum brazing which is carried out at relatively low atmosphere pressure in the order of about 1×10⁻⁵ mbar or less, and is an essentially discontinuous process and puts high demands on material cleanliness. To obtain the optimum conditions for joining to take place, aluminium alloys commonly used for vacuum brazing contain purposive additions of Mg of 1% or more. The Mg destroys the hard oxide film of the filler alloy when it evaporates from the brazing sheet during brazing, and further the evaporated Mg plays the role as getter that removes oxygen and moisture remaining in the brazing furnace. There is always more magnesium present in the furnace then necessary. The excess magnesium condenses on the cold sports in the vacuum furnace and has to be removed frequently. The capital investment for suitable equipment is relatively high.

NOCOLOK™ (registered trademark of Alcan) flux brazing has been used as the principal brazing process to braze automotive heat exchangers by many heat exchanger manufacturers. Major problems that have arisen from the NOCOLOK process have been flux costs, flux handling and the damage flux causes to the furnaces. Also, in complex shaped assemblies the application of the non-corrosive brazing flux prior to brazing at the interior of the assemblies is often considered very difficult and problematic. Consequently, most of the heat exchanger manufacturers have been trying to reduce flux consumption.

Another brazing process is controlled atmosphere brazing (“CAB”) without using a brazing flux. This process is in particular being used for joining by means of brazing of surfaces inside a heat exchanger with are very difficult to flux.

European patent document EP-1430988-A discloses for such a process of CAB without using a brazing flux that the brazing sheet product used contains Mg at least in a layer constituting the brazing sheet other than the filler alloy layer, typically the core alloy contains Mg in a range of 0.05% to 1.0 wt. %. Interposed between the core alloy and the filler alloy there is present a diffusion prevention layer such a Mg-free AA3003-series aluminium alloy.

European patent document EP-1306207-B1 discloses another fluxless brazing process in an inert gas atmosphere containing very low oxygen content of up to 1000 ppm, and preferably up to 500 ppm. Furthermore there is disclosed a brazing sheet product comprising of an aluminium core alloy on one or both sides clad with an Al—Si alloy brazing alloy containing 0.1% to 5% of Mg and 0.01% to 0.5% of Bi as an intermediate layer, and a further metal layer onto the outer surface of the Al—Si alloy brazing alloy. It is disclosed that during a brazing operation the brazing material in the intermediate layer is molten as the temperature is elevated during brazing, but oxidation of the surface of the brazing material does not occur because the surface is covered with the thin metal layer which remains solid.

European patent document EP-1430988-A1 discloses in its paragraph [0015] there is another method of inert gas atmosphere brazing called VAW method in which flux is not used. In this method, brazing is enabled in an inert gas atmosphere by adding minute amounts of Bi, Sb, Ba, Sr, Be, etc to filler alloys and destroying and removing the oxide film on the surface of the filler alloy by means of alkali etching or acid etching before braze heating. However in this method, the atmosphere must be strictly controlled to a dew point of −65° C. or less and an oxygen concentration of 5 ppm or less. Moreover, pretreatment of material is necessary and strict control of the atmosphere is necessary, and it is explicitly mentioned that this method is not suitable in terms of practical use. In this document no details are disclosed about the brazing method itself nor of the exact composition of the filler alloy.

U.S. Pat. No. 4,908,184 discloses a high strength, corrosion-resistant core alloy for brazing, the core alloy consists of 0.5-1.0% Cu, 0.1-0.5% Mg, 0.2-1.0% Si, and one or more of Zr, Cr and Mn each in the amount of 0.05-0.5%, and the balance of aluminium and inevitable impurities, and wherein the weight ratio of Si/Mg is in the range of 1-2.5. Optionally, Ni may be added in a range of 0.05-0.5%. Filler metals that can be applied to the core alloy include Al—Si alloys, Al—Si—Bi alloys, Al—Si—Mg alloys, Al—Si—Mg—Bi alloys.

European patent document EP-1686343-A2 discloses a heat exchanger comprising of i) a fin material having a triple-layer clad material, and ii) an aluminium alloy tube having a Zn concentrated surface, the both having been brazed to each other using a brazing material composed of an Al—Si alloy containing 6.5-13.0% Si, 0.15-0.60% Cu, and optionally 0.05-0.30% Mn.

US published patent application no. 2004/0028940-A1 discloses an aluminium alloy fin material for heat exchangers which has a thickness of 80 micron or less and is incorporated into a heat exchanger made of an aluminium alloy manufactured by brazing through an Al—Si alloy filler metal. When used in a vacuum brazing method, Mg is added to the filler metal in an amount of 2.0% or less. In the case of applying inert atmosphere brazing using a fluoride flux, the Mg content is preferably limited to 0.5% or less since Mg hinders brazability due to its interaction with the brazing flux.

There is a need for further improved brazing processes and brazing sheet materials in which at least the interior side of an assembly does not have to be provided with a brazing flux.

### DESCRIPTION OF THE INVENTION

It is an object of the invention to provide an alternative aluminium alloy brazing sheet material that can be applied in a controlled atmosphere fluxless brazing process without applying a brazing flux.

It is another object of the invention to provide an alternative aluminium alloy brazing sheet material that can be applied in a controlled atmosphere fluxless brazing process without applying a brazing flux and at a brazing furnace temperature of 590° C. or less.

It is yet another object of the invention to provide an alternative aluminium alloy brazing sheet material that can be applied in a controlled atmosphere fluxless brazing process without applying a brazing flux and at a brazing furnace temperature of 585° C. or less.

These and other objects and further advantages are met or exceeded by the present invention providing a process of joining at least two aluminium alloy workpieces by means of controlled atmosphere brazing comprising of brazing an aluminium alloy without flux in a controlled atmosphere utilizing an inert gas atmosphere, while using a brazing sheet product comprising an aluminium alloy core upon which on at least one side a layer of filler alloy is clad, the filler clad layer having an inner-surface and an outer-surface, the inner-surface is facing the core and preferably the outer-surface is devoid of any further metallic based layers, in particular metallic layers based on Ni, Fe, and Co, and alloys thereof, and wherein the filler alloy has a composition which is Na-free, Li-free, K-free, and Ca-free, and comprising, in wt. %:
Si 3% to 15%
Mg 0.05% to 1%
Cu 0.3 to about 5%,
at least one or more elements selected from the group consisting of:
   Bi 0.03% to 0.35%, Pb 0.03% to 0.2%, Sb 0.03% to 0.2%, and the sum of these elements being 0.35% or less,
Fe 0 to about 0.6%
Mn 0 to about 1.5%,
the balance aluminium and incidental impurities.

### BRIEF DESCRIPTION OF THE DRAWINGS

FIGS. 1a to 1d are schematic diagrams of embodiments of the brazing sheet used in the present invention.

FIG. 2 is a schematic diagram of an aluminium alloy tube for a heat exchanger made with the present invention.

### DETAILED DESCRIPTION OF PREFERRED EMBODIMENTS

As will be appreciated herein below, except as otherwise indicated, alloy designations refer to the Aluminum Association designations in Aluminum Standards and Data and the Registration Records, as published by the Aluminum Association in 2008.

For any description of alloy compositions or preferred alloy compositions, all references to percentages are by weight percent unless otherwise indicated. The term “up to” and “up to about”, as employed herein, explicitly includes, but is not limited to, the possibility of zero weight-percent of the particular alloying component to which it refers. For example, up to about 0.2% Ti may include an alloy having no Ti.

For the purposes of this invention, and as used hereinafter, the term “controlled atmosphere brazing” or “CAB” refers to a brazing process which utilizes an inert atmosphere, for example, nitrogen, argon or helium in the brazing of aluminium alloy articles. CAB is distinct from vacuum brazing in particular in that with CAB the brazing atmosphere in the furnace during the brazing operation is at about regular atmospheric pressure, although a slight under-pressure (for example working at a pressure of 0.1 bar or more) or having a slight over-pressure can be used to facilitate the control of the inert atmosphere and to prevent an influx of oxygen containing gas into the brazing furnace. “Core” means an aluminium alloy which is the structural support for the aluminium alloy that is used as the filler. “Filler” means an aluminium alloy which is used to braze the core or other aluminium articles. “Cladding” is used to describe the use of the filler when it is overlaid on one or both surfaces of the core, optionally with the application of an intermediate layer between the core and the cladding to act as a diffusion barrier or to improve on the corrosion resistance of the product after brazing. Thereafter, the clad core is called a composite or a brazing sheet. “Fillet” means a concave junction between two surfaces.

The process according to this invention allows for the manufacture of brazed assemblies incorporating aluminium workpieces, and wherein a controlled atmosphere brazing process is utilised in which at least the interior side of an assembly does not have to be provided with a brazing flux. It has been found that also the exterior side of an assemby does not need to be provided with a brazing flux.

The filler alloy is free of each of the elements Na, Li, K, and Ca to avoid any interference with the Bi and Mg during the brazing operation. With “free” is meant that no purposeful addition of Na, Li, K, and Ca was made to the chemical composition but that due to impurities and/or leaking from contact with manufacturing equipment, trace quantities of Na, Li, K, and Ca may nevertheless find their way into the filler alloy product. For example, less than 0.008% is an example of a trace quantity.

It is another important feature of the invention that the brazing sheet product used in the method is devoid of any further metallic layer applied onto the outer surface of the filler alloy, which are added in the prior art to facilitate the controlled atmosphere brazing operation. In accordance with this invention it has been found that a very good filler formation is achieved in a controlled atmosphere brazing process without the use of a brazing flux material, such as for example used in the NOCOLOK brazing process, and without the use of a Ni- or Ni-alloy layer used in the prior art to facilitate the fluxless CAB operation, for example as disclosed in international application WO-01/068312 in which also the use of a bonding layer between the AlSi clad layer and the Ni-layer is disclosed. It is considered to be known in the art that instead of a Ni-layer also a Fe-layer or a Co-layer, or alloys thereof, can be used to facilitate a fluxless brazing operation, although Fe- and Co-layers are used on a less preferred basis than Ni-layers. Other metallic layers described in the prior art to facilitate fluxless or flux-free brazing in a CAB environment are for example disclosed in European patent document EP-1306207-B1, where a top-layer of an AA1xxx-series aluminium alloy having a melting point higher than the AlSi filler alloy is being applied. It is an important feature of the present invention that such metallic layers, e.g., Ni—, Fe—, Co—, Al—or alloys thereof, are no longer required when the filler alloy of this invention is being used in the controlled atmosphere brazing operation. This leads to considerable costs saving when producing the brazing sheet product. Furthermore, the use of for example a Ni-layer results in a reduced corrosion resistance of the product in the post-braze condition, which disadvantage does not occur in the present invention.

Several advantages are obtained by the present filler material in the controlled atmosphere brazing process. The present invention concerns a truly fluxless aluminium brazing process that does not require a vacuum furnace, nor a brazing flux like a fluoride flux (e.g. NOCOLOK™) or other costly, unique capital equipment. The parts or workpieces are brazed in a furnace containing an inert gas, a non-oxidizing gas preferably nitrogen or argon. The preferred incoming gas has about 500 ppm of oxygen or less, and more preferably of 100 ppm of oxygen or less, and most preferably of 25 ppm of oxygen or less. By carefully controlling the amount of Mg and Bi in the filler alloy, both elements are purposively added to the filler alloy, good fillet formation is obtained in the fluxless controlled atmosphere brazing process. As an alternative for adding Bi to the filler alloy, the Bi can be replaced in part or in whole by lead or antimony or in combination. However, Pb and/or Sb are used on a less preferred basis. Ideally only Bi is being added to the filler alloy in the range of 0.03% to 0.35%. A preferred upper limit is about 0.2%. A preferred lower limit for the Bi addition is 0.06%.

It is an important feature of the current invention that Cu is purposively being added to the filler alloy in order to lower the solidus temperature or melting point of the filler alloy for which purpose it can be added up to about 5%. In a preferred embodiment the Cu content does not exceed 2%, and more preferably it does not exceed 1.7%. The Cu should be added in an amount of at least 0.1%, preferably of at least about 0.3%, more preferably it is at least about 0.5%, and more preferably at least 0.6%, for example, there may be at least 0.8% Cu.

The purposive addition of Cu results in lowering the solidus temperature of the filler alloy, whereby the solidus temperature is the onset of melting of the filler alloy.

The solidus temperature may be lowered to a range of about 520° C. to 575° C., for example about 550° C. or about 560° C., and thereby allowing a brazing operation to be carried out at a lower furnace temperature, typically in range of about 540° C. to 590° C. and more preferably of 550° C. to 585° C., resulting in significant economical advantages. A lower applied brazing temperature is beneficial also for increasing the sagging resistance of the aluminium fin alloys used in the brazed assembly.

The purposive addition of Cu in the defined amounts will influence the galvanic corrosion behaviour of the filler alloy and thus of the brazed assembly in which it is being employed. For those applications that this is an undesired effect it is preferred that the filler alloy may further contain one or more elements selected from the group of: Zn 0.2% to 1.5%, Sn 0.02% to 1%, In 0.01% to 0.25%, to counter in whole or at least in part the effect of Cu on the corrosion potential. Where the addition of Cu makes the aluminium alloy more noble and the addition of one or more of Zn, Sn, and In make the alloy less noble, if so desired or required the combined additions can be tailored such that their contributions to the corrosion potentials are effectively balanced out and maintaining a substantially neutral corrosion potential in comparison with regular AA4045 as filler alloy. Indium is much more effective in reducing the corrosion potential as compared to zinc additions. However, it is also much more expensive. It can be added up to 0.25%, and a more preferred range for In is about 0.01% to 0.10%.

For practical reasons it is preferred to add only Zn. In a preferred embodiment the amount of Zn does not exceed 0.95%. To take benefit for the addition of Zn in combination with the Cu addition, the lower-limit for the Zn addition is at least 0.2%, and more preferably at least 0.4%. If not purposively added Zn can be tolerated as impurity element up to 0.25%.

In a preferred embodiment the Bi content is in a range of at least 0.06%, and more preferably of at least 0.08%. A preferred upper-limit for the Bi content is 0.14%. Typically the Bi is added in an amount of about 0.1%.

The Mg content in the filler alloy should be carefully controlled and should not exceed 1%. A preferred upper-limit for the Mg addition is 0.50%, more preferably about 0.30%, and more preferably 0.20%. Typically the Mg is added in an amount of about 0.1%. At present the quality and control mechanisms when producing aluminium brazing sheet allow for the target and the control of Mg within an accuracy of ±0.01% or better. A too high Mg content in the filler alloy results in an undesirable interaction with any oxygen in the controlled inert gas atmosphere and disrupts the formation of a smooth and acceptable fillet. Favourably, the addition of Mg also, in combination with the Cu and possibly also in combination with the Zn, results in a contribution to a further reduction of the solidus temperature of the filler alloy.

In the embodiment that Bi is added, and preferably solely Bi is being added, to the filler alloy it is further preferred that excess Mg content with respect to the stoichiometric composition of Bi₂Mg₃ is 0.07% or less, and preferably 0.05% or less, but more than 0%. It has been found that Bi has a low solubility in aluminium and tends to separate out at the grain boundaries even when added at low levels of for example 0.1% or 0.15%. This can result in an undesirable white dusty appearance of the brazing sheet when kept on stock for a long period of time. To overcome this effect a small amount of Mg will form Bi_{2Mg}₃ which stops separation at the grain boundaries. This Bi₂Mg₃ phase will however dissolve in the filler alloy at melting of the brazing material releasing the Bi to lower the surface tension of the molten filler.

The Si content in the filler alloy should be in the range of about 3% to about 15%, and preferably in the range of about 6% to about 13%. For example, the Si content is about 10% or about 12.5%.

The amount of Fe present in the filler alloy depends primarily on the origin of the alloy material and can be up to about 0.6%, and preferably is not more than about 0.4%.

As grain refiner element Ti can be present in the brazing material in a range of up to about 0.2%, preferably up to 0.15%.

Mn can be present in the filler alloy in a range of 0 to about 1.5%. When present as impurity it can be tolerated to 0.3%. However, it may also be purposively added in a range of 0.3% to 1.5%. A more preferred upper-limit for the Mn addition is 1.0%.

The balance is made by unavoidable or incidental impurities, typically each 0.05% maximum, and the total 0.15% maximum, and aluminium.

In an embodiment the filler alloy it may further Sr in a range of 0 to 0.05% to modify the silicon in the filler alloy and to improve the flowability of the molten filler in the brazing operation.

In an embodiment the filler alloy has a composition which is Na-free, Li-free, K-free, and Ca-free, and consists of, in wt. %:
Si 3% to 15%, preferably 6% to 15%, for example 10% or about 12%,
Cu 0.3% to 5%, preferably 0.3% to 2%, more preferably 0.4% to 1.7%,
Mg 0.05% to 1%, preferably 0.05% to 0.5%,
one or more elements selected from the group consisting of:
   Bi 0.03% to 0.35%, Pb 0.03% to 0.2%, Sb 0.03% to 0.2%, and the sum of these elements being 0.35% or less,
Fe 0 to 0.6%, for example 0.2% or 0.3%,
Mn 0 to 1.5%, for example 0 or 0.5%,
Zn 0 to 1.5%, preferably 0.2% to 1.5%, more preferably 0.4% to 0.95%,
Ti 0 to 0.15%, for example 0.01% or 0.1%,
Sr 0 to 0.05%, for example 0 or 0.02%,
the balance aluminium and incidental impurities.

In another embodiment the filler alloy has a composition which is Na-free, Li-free, K-free, and Ca-free, and consists of, in wt. %:
Si 3% to 15%, preferably 6% to 15%, for example 10% or about 12%, Cu 0.3% to 5%, preferably 0.3% to 2%, more preferably 0.4% to 1.7%,
Mg 0.05% to 1%, preferably 0.05% to 0.5%,
Bi 0.03% to 0.35%, preferably 0.06 to 0.2%,
Fe 0 to 0.6%, for example 0.2% or 0.3%,
Mn 0 to 1.5%, for example 0 or 0.4%,
Zn 0 to 1.5%, preferably 0.2 to 1.5%, more preferably 0.4 to 0.95%,
Ti 0 to 0.15%, for example 0.01%,
Sr 0 to 0.05%, for example 0 or 0.02%,
the balance aluminium and incidental impurities.

The filler material is clad to aluminium core alloys to form brazing sheet, including clad fin stock. Preferably the core alloy is made of an aluminium alloy from the 2xxx, 3xxx, 5xxx, 6xxx or 7xxx-series alloys, for example an AA3003, AA3005, AA6060 or AA6063-type alloy.

In an embodiment a further metal can be interposed between the core alloy layer and the filler alloy clad material. For example a further aluminium alloy layer may be applied for example to limit diffusion of alloying elements from the core layer to the filler layer or to further improve the corrosion performance of the brazing sheet product.

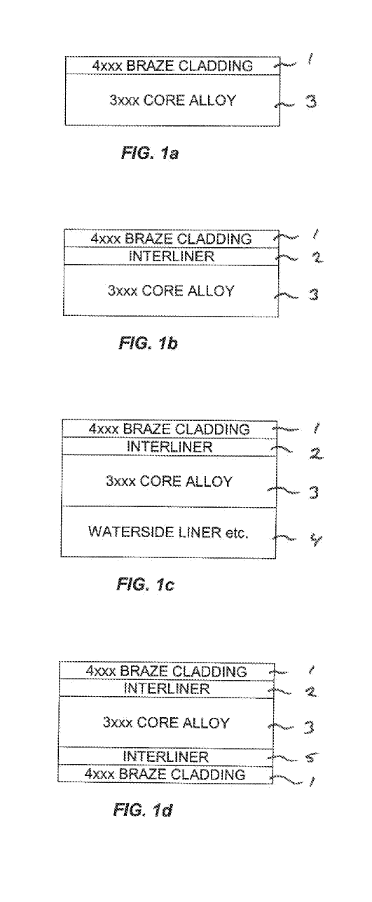

FIG. 1a shows a schematic diagram of the brazing sheet comprising of an aluminium core alloy (3), for example a 3xxx-series alloy, clad on one side with a 4xxx-series braze cladding layer (1) as described in this description.

FIG. 1b shows a schematic diagram of the brazing sheet comprising of an aluminium core alloy (3), for example a 3xxx-series alloy, clad on one side with a 4xxx-series braze cladding layer (1) as described in this description, and whereby there is provided an interliner or interliner layer (2) interposed between the core layer (3) and the braze cladding layer (1).

FIG. 1c shows a schematic diagram similar to that of FIG. 1b, and whereby on the other side of the core layer (3) there is provide a layer (4) that may act as a sacrificial anode, for example a waterside liner.

FIG. 1d shows a schematic diagram analogue to that of FIG. 1b, and whereby the interliner layer (2) and the braze cladding layer (1) are provided on each side of the core alloy layer (3).

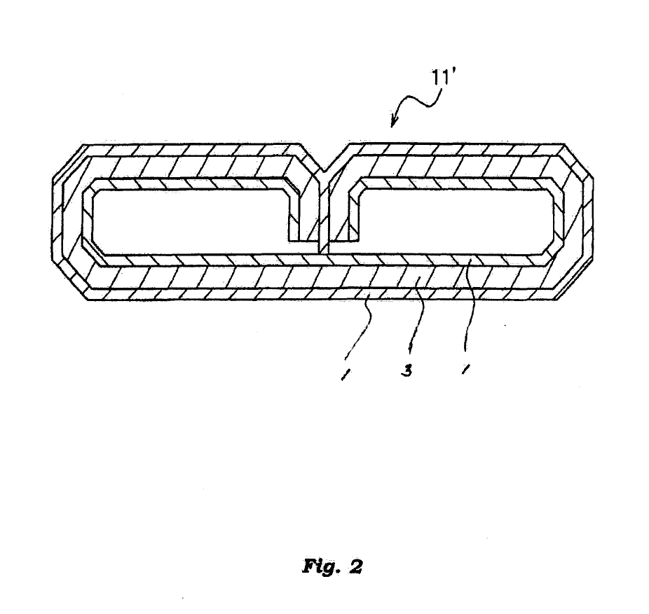

FIG. 2 shows a schematic diagram of an aluminium alloy tube (11′) for a heat exchanger manufactured via the method of this invention and using a brazing sheet comprising of a core alloy layer (2) on both sides clad with a 4xxx-series brazing clad layer (1) and whereby the brazing sheet is folded to form a hollow structure or tube. The hollow structure can be brazed without using a flux on the inner side of the hollow structure.

The brazing sheet material used according to this invention can be manufactured via various techniques. For example by roll bonding as is well known in the art. Alternatively the filler alloy layer can be applied onto the core alloy layer by means of thermal spraying techniques. Or alternatively the core alloy layer and the filler alloy clad material can be manufactured by means of casting techniques, for example as disclosed in international application WO-2004/112992.

Ideally, when assembling the components into an assembly suitable for joining by controlled atmosphere brazing utilizing an inert gas atmosphere, one side of the brazing sheet of the invention having aluminium-silicon filler is being kept inside the assembly forming the brazing sheet to constitute a hollow structure. While using such a brazing sheet product there is no need to apply a flux to obtain a good joint with the brazing operation.

Thus, in another aspect of the invention there is provided a method of manufacturing an assembly of brazed components, comprising the steps of:

(i) forming the components of which at least one is made from an aluminium alloy brazing sheet described in this description as part of the invention;

(ii) assembling the components into an assembly, and wherein at least one side of the brazing sheet having aluminium-silicon filler alloy with balanced addition of Cu, Mg and Bi is being kept inside the assembly to constitute a hollow structure;

(iii) joining the components by brazing the assembly without applying flux in the hollow structure and without applying a flux on the outside of the assembly of components and brazing the whole assembly in an inert gas atmosphere at a brazing temperature in the range of about 560° C. to 590° C., and preferably of 570° C. to 590° C., and more preferably of not more than 585° C., for a period long enough for melting and spreading of the filler material;

(iv) cooling the brazed assembly, typically to a temperature of below 100° C.

Another aspect of the invention relates to a novel use or method of use of such a filler alloy in a fluxless controlled atmosphere brazing process utilizing an inert gas atmosphere. The aluminium filler alloy being described as herein above and set forth in the claims, together with its preferred embodiments.

In particular it relates to the method of use of an aluminium-silicon filler alloy in a process of joining at least two aluminium alloy workpieces by means of brazing in a controlled atmosphere without the use of a flux, preferably at a brazing temperature in a range of about 560° C. to 590° C., and more preferably of about 570° C. to 585° C., and wherein the aluminium-silicon filler has a composition which is Na-free, Li-free, K-free, Ca-free, and comprising, in wt. %:
Si 3% to 15%, preferably 6% to 15%,
Cu 0.3% to 5%, preferably 0.3% to 2%,
Mg 0.03% to 1%, preferably 0.03% to 0.5%,
one or more elements selected from the group consisting of:
   Bi 0.03 to 0.35, Pb 0.03 to 0.2, Sb 0.03 to 0.2, and the sum of these elements being 0.35% or less,
Fe 0 to 0.6%
Mn 0 to 1.5%,
the balance aluminium and incidental impurities.

In another embodiment the invention relates to the use of an aluminium-silicon filler alloy in a process of joining two aluminium alloy workpieces by means of brazing in a controlled atmosphere without the use of a flux, preferably at a brazing temperature in a range of about 560° C. to 590° C., and more preferably of about 570° C. to 585° C. and wherein the aluminium-silicon filler has a composition which is Na-free, Li-free, K-free, Ca-free, and consists of, in wt. %:
Si 3% to 15%, preferably 6% to 15%,
Cu 0.3% to 5%, preferably 0.5 to 2%, more preferably 0.5% to 1.7%,
Mg 0.05% to 1%, preferably 0.05% to 0.5%,
one or more elements selected from the group consisting of:
   Bi 0.03% to 0.35%, Pb 0.03% to 0.2%, Sb 0.03% to 0.2%, and the sum of these elements being 0.35% or less,
Fe 0 to 0.6%
Mn 0 to 1.5%
Zn 0 to 1.5%, preferably 0.2% to 1.5%, more preferably 0.4% to 0.95%,
Cu 0 to 0.3%
Ti 0 to 0.15%
Sr 0 to 0.05%,
the balance aluminium and incidental impurities.

In another embodiment it relates to the use of an aluminium-silicon filler alloy in a process joining of two aluminium alloy workpieces by means of brazing in a controlled atmosphere without the use of a flux, preferably at a brazing temperature in a range of about 560° C. to 590° C., and more preferably of about 570° C. to 585° C., and wherein the aluminium-silicon filler has a composition which is Na-free, Li-free, K-free, Ca-free, and consists of, in wt. %:
Si 3% to 15%, preferably 6% to 15%,
Cu 0.3% to 5%, preferably 0.5 to 2%, more preferably 0.5% to 1.7%,
Mg 0.05% to 1%, preferably 0.05% to 0.5%,
Bi 0.03% to 0.35%, preferably 0.06 to 0.2%,
Fe 0 to 0.6%
Mn 0 to 1.5%
Zn 0 to 1.5%, preferably 0.2% to 1.5%, more preferably 0.4% to 0.95%,
Cu 0 to 0.3%
Ti 0 to 0.15%
Sr 0 to 0.05%,
the balance aluminium and incidental impurities.

In the following, the invention will be explained by the following non-limitative examples.

### Example 1

Brazing sheets have been produced consisting of a core alloy of a commercial AA3003-series alloy and a filler alloy having a composition as listed in Table 1, and wherein filler alloy 1 is illustrating the effect of the purposive addition of Bi and Mg and filler alloy 2 is a comparative example. The brazing sheets have been produced via roll bonding, and have a final gauge of 0.3 mm and the clad layer thickness was 30 micron. The clad filler alloy has been applied on one side of the core sheet only, and the outer-surface of the clad filler alloy was bare and thus devoid of any further metallic layers.

TABLE 1
Alloy composition of the filler alloy, in wt. %, balance is made
by aluminium and unavoidable impurities.

Alloying element

| Filler alloy | Si | Fe | Bi | Mg |
|---|---|---|---|---|
| 1 | 10.8 | 0.15 | 0.1 | 0.1 |
| 2 | 11.1 | 0.15 | — | — |

The brazeability of the brazing sheet products have been assessed on a laboratory scale of testing in a small quartz furnace. Small coupons of 25 mm×25 mm were cut from the brazing sheet products. A small strip of an AA3003 alloy measuring 30 mm×7 mm×1 mm was bent in the centre to an angle of 45° and laid on the coupons. The strip on the coupon samples were heated under flowing nitrogen of atmospheric pressure and having an oxygen content of less than 20 ppm, with heating from room temperature to 590° C., dwell time at 590° C. for 1 minute, cooling from 590° C. to room temperature. The brazed samples were assessed for the amount of fillet formed at the periphery of the AA3003 in contact with the brazing sheet products and expressed in %, for example, if no fillet was formed then the amount of fillet is 0%, and when a fillet is formed around the whole periphery then the amount of fillet is 100%.

It was found that the brazing sheet having the filler alloy 1 when brazed in a controlled atmosphere in the absence of a flux material had an excellent fillet formation of 100%, whereas the filler alloy 2 had a fillet formation of 0%. This example illustrates to excellent filet formation that can be obtained in a fluxless controlled atmosphere brazing operation when using brazing sheet with a filler alloy having careful controlled amounts of Bi and Mg, while being free from Na, Li, K, and Ca, and having no metallic layers, such as Ni or Co or a 1xxx-series clad layer, which are disclosed in the prior art as being required to facilitate the brazing operation.

### Example 2

Brazing sheets have been produced consisting of a core alloy of a commercial AA3003-series alloy and a filler alloy having a composition as listed in Table 2, and wherein filler alloy 3 is according to this invention and filler alloy 2 is a comparative example, similar as in Example 1. The brazing sheets have been produced via roll bonding, and have a final gauge of 0.3 mm and the clad layer thickness was 30 micron. The clad filler alloy has been applied on one side of the core sheet only, and the outer-surface of the clad filler alloy was bare and thus devoid of any further metallic layers.

TABLE 2
Alloy composition of the filler alloy, in wt. %, balance is made by
aluminium and unavoidable impurities.

| | |
|---|---|
| Filler | Alloying element |

| alloy | Bi | Cu | Fe | Mg | Si | Zn |
|---|---|---|---|---|---|---|
| 2 | 0.18 | 1.3 | 0.24 | 0.11 | 12.4 | 0.9 |
| 3 | — | — | 0.15 | — | 11.1 | <0.01 |

Via DSC measurements the onset of melting has been measured and the melting range. Filler alloy 2 has an onset of melting of 548° C. and a melting range of 548 to 590° C. Filler alloy 3 has an onset of melting of 576° C. and a melting range of 576 to 600° C.

The brazeability of the brazing sheet products have been assessed on a laboratory scale of testing in a small quartz furnace. Small coupons of 25 mm×25 mm were cut from the brazing sheet products. A small strip of an AA3003 alloy measuring 30 mm×7 mm×1 mm was bent in the centre to an angle of 45° and laid on the coupons. The strip on the coupon sample with filler alloy 2 was heated under flowing nitrogen of atmospheric pressure and having an oxygen content of less than 20 ppm, with heating from room temperature to 585° C., dwell time at 585° C. for 1 minute, cooling from 585° C. to room temperature. Whereas, the strip on the coupon sample with filler alloy 3 was heated under flowing nitrogen of atmospheric pressure and having an oxygen content of less than 20 ppm, with heating from room temperature to 590° C., dwell time at 590° C. for 1 minute, cooling from 590° C. to room temperature.

The brazed samples were assessed for the amount of fillet formed at the periphery of the AA3003 in contact with the brazing sheet products and expressed in %, for example, if no fillet was formed then the amount of fillet is 0%, and when a fillet is formed around the whole periphery then the amount of fillet is 100%.

It was found that the brazing sheet having the filler alloy according to this invention when brazed in a controlled atmosphere in the absence of a flux material had an excellent fillet formation of 100%, whereas the filler alloy 3 had a fillet formation of 0%. This example illustrates to excellent filet formation that can be obtained in a fluxless controlled atmosphere brazing operation at significantly lower brazing temperature when using brazing sheet with a filler alloy having careful controlled amounts of Cu, Zn, Bi and Mg, while being free from Na, Li, K, and Ca, and having no metallic layers, such as Ni or Co, which are disclosed in the prior art as being required to facilitate the brazing operation.

While various embodiments of the technology described herein have been described in detail, it is apparent that modifications and adaptations of those embodiments will occur to those skilled in the art. However, it is to be expressly understood that such modifications and adaptations are within the spirit and scope of the presently disclosed technology.

1. A process for controlled atmosphere brazing comprising, brazing an aluminium alloy without flux in a controlled atmosphere utilizing an inert gas atmosphere, while using brazing sheet comprising of an aluminium alloy core upon which on at least one side a layer of filler alloy is clad, the filler clad layer having an inner-surface and an outer-surface, the inner-surface is facing the core, and wherein the filler alloy has a composition which is Na-free, Li-free, K-free, and Ca-free, and comprising, in wt. %:
Si 3% to 15%,
Cu 0.3% to about 5%,
Mg 0.05% to 1%,
one or more elements selected from the group consisting of:
Bi 0.03 to 0.35, Pb 0.03 to 0.2, and Sb 0.03 to 0.2, and the sum of these elements being 0.35% or less,
Fe 0 to about 0.6%,
Mn 0 to about 1.5%,
the balance aluminium and incidental impurities.

2. The process for controlled atmosphere brazing according to claim 1, wherein the filler alloy further comprises one or more elements selected from the group of: Zn 0.2 to 1.5%, Sn 0.02 to 1%, and In 0.01 to 0.25%.

3. The process for controlled atmosphere brazing according to claim 1, wherein the filler alloy comprises solely Bi selected from the group of elements Bi, Pb, Sb.

4. The process for controlled atmosphere brazing according to claim 1, wherein the filler alloy has a Bi-content in a range of 0.06% to 0.2%.

5. The process for controlled atmosphere brazing according to claim 1, wherein the filler alloy has a Bi-content in a range of 0.06% to 0.14%.

6. The process for controlled atmosphere brazing according to claim 1, wherein the filler alloy has a Bi-content in a range of at least 0.08%.

7. The process for controlled atmosphere brazing according to claim 1, wherein the filler alloy has a Mg-content in a range of 0.05% to 0.5%.

8. The process for controlled atmosphere brazing according to claim 1, wherein the filler alloy has a Mg-content in a range of 0.05% to 0.30%.

9. The process for controlled atmosphere brazing according to claim 1, wherein the filler alloy has a Mg-content in a range of 0.05% to 0.20%.

10. The process for controlled atmosphere brazing according to claim 1, wherein the filler alloy has excess Mg with respect to the stoichiometric composition of Bi₂Mg₃ is in a range of 0% to 0.07%.

11. The process for controlled atmosphere brazing according to claim 1, wherein the filler alloy has excess Mg with respect to the stoichiometric composition of Bi₂Mg₃ is in a range of 0% to 0.05%.

12. The process for controlled atmosphere brazing according to claim 1, wherein the filler alloy has a Cu-content in a range of up to 2%.

13. The process for controlled atmosphere brazing according to claim 1, wherein the filler alloy has a Cu-content in a range of 0.1% to 1.7%.

14. The process for controlled atmosphere brazing according to claim 1, wherein the filler alloy has a Cu-content in a range of 0.3% to 1.7%.

15. The process for controlled atmosphere brazing according to claim 1, wherein the filler alloy has a Zn-content in a range of up to 0.95%.

16. The process for controlled atmosphere brazing according to claim 1, wherein the filler alloy has a Zn-content in a range of at least 0.4%.

17. The process for controlled atmosphere brazing according to claim 1, wherein the outer surface of the filler clad layer is devoid of any further metallic based layers.

18. The process for controlled atmosphere brazing according to claim 1, wherein the filler alloy has a composition which is Na-free, Li-free, K-free, and Ca-free, and consists of, in wt. %:
Si 3% to 15%
Cu 0.3 to 2%
Mg 0.05% to 1%
Bi 0.03% to 0.35%
Fe 0 to 0.6%
Mn 0 to 1.5%
Zn 0 to 1.5%
Ti 0 to 0.15%
Sr 0 to 0.05%,
the balance aluminium and incidental impurities.

19. The process for controlled atmosphere brazing according to claim 1, wherein the controlled atmosphere is a non-oxidizing gas and containing less than 100 ppm of oxygen.

20. A method of manufacturing an assembly of brazed components, comprising the steps of:
(i) providing components of which at least one is made from an aluminium alloy brazing sheet;
(ii) assembling the components into an assembly, and wherein at least one side of the brazing sheet having aluminium-silicon filler alloy kept inside the assembly to constitute a hollow structure;
(iii) joining the components by brazing the assembly without applying flux in the hollow structure and without applying a flux on the outside of the assembly of components and brazing the whole assembly in an inert gas atmosphere at a brazing temperature in the range of about 560° C. to 590° C. for a period long enough for melting and spreading of the filler material;
(iv) cooling the brazed assembly, typically to a temperature of below 100° C.,
wherein brazing sheet comprising of an aluminium alloy core upon which on at least one side a layer of filler alloy is clad, the filler clad layer having an inner-surface and an outer-surface, the inner-surface is facing the core, and wherein the filler alloy has a composition which is Na-free, Li-free, K-free, and Ca-free, and comprising, in wt. %:
Si 3% to 15%,
Cu 0.3% to about 5%,
Mg 0.05% to 1%,
one or more elements selected from the group consisting of:
(Bi 0.03 to 0.35, Pb 0.03 to 0.2, and Sb 0.03 to 0.2, and the sum of these elements being 0.35% or less),
Fe 0 to about 0.6%,
Mn 0 to about 1.5%,
the balance aluminium and incidental impurities.

21. The method according to claim 20, wherein the filler alloy further comprises one or more elements selected from the group of: Zn 0.2 to 1.5%, Sn 0.02 to 1%, and In 0.01 to 0.25%.

22. The method according to claim 20, wherein the filler alloy comprises solely Bi selected from the group of elements Bi, Pb, Sb.

23. The method according to claim 20, wherein the controlled atmosphere is a non-oxidizing gas and containing less than 25 ppm of oxygen.

24. The method according to claim 20, wherein the filler alloy has a Mg-content in a range of 0.05% to 0.5%.

25. The method according to claim 20, wherein the filler alloy has a Cu-content in a range of up to 2%.

26. The method according to claim 20, wherein the filler alloy has a Cu-content in a range of 0.1% to 1.7%.

27. The method according to claim 20, wherein the filler alloy has a Cu-content in a range of 0.3% to 1.7%.

28. The method according to claim 20, wherein the filler alloy has a Zn-content in a range of up to 0.95%.
